(19) United States
(12) Patent Application Publication
(10) Pub. No.: US 2014/0291033 A1
(43) Pub. Date: Oct. 2, 2014

(54) METHODOLOGIES FOR MANUFACTURING SHORT MATRIX BITS

(71) Applicants: Marvin Windsor Amundsen, Houston, TX (US); Charles Daniel Johnson, Porter, TX (US)

(72) Inventors: Marvin Windsor Amundsen, Houston, TX (US); Charles Daniel Johnson, Porter, TX (US)

(73) Assignee: VAREL INTERNATIONAL IND., L.P., Carrollton, TX (US)

(21) Appl. No.: 14/219,719

(22) Filed: Mar. 19, 2014

Related U.S. Application Data
(60) Provisional application No. 61/807,651, filed on Apr. 2, 2013.

(51) Int. Cl. E21B 10/00; B23K 15/00; B23K 1/002; B23K 26/20; B23K 20/12; B23K 1/008; B23P 15/28; B23K 10/02

(52) U.S. Cl. CPC E21B 10/00; B23P 15/28; B23K 15/0046; B23K 10/02; B23K 26/20; B23K 20/129; B23K 1/008; B23K 1/002
USPC 175/327; 76/108.4; 219/121.14; 219/121.46; 219/121.64; 228/113; 228/221; 228/101; 219/615

(57) ABSTRACT

A downhole tool and method for manufacturing such downhole tool. The downhole tool includes a bit body having a blank and a matrix bonded to and surrounding the blank, a shank having a threaded connection at one end, and a butt joint formed within a gap formed between the blank and the shank and coupling the blank to the shank. The blank includes a first planar surface while the shank includes a second planar surface opposite the one end. The butt joint is formed between the first and second planar surfaces when positioned adjacent to one another, wherein the first planar surface is positioned external to the matrix.

### RELATED APPLICATIONS

The present application is a non-provisional application of and claims priority under 35 U.S.C. §119 to U.S. Provisional Application No. 61/807,651, entitled “Methodologies for Manufacturing Short Matrix Bits” and filed on Apr. 2, 2013, the entirety of which is incorporated by reference herein.

### BACKGROUND

This invention relates generally to drill bits used in downhole drilling. More particularly, this invention relates to a matrix drill bit, such as a tungsten carbide matrix drill bit, having an overall reduced bit height and the methods for manufacturing the same.

Underground drilling, such as gas, oil, or mining, generally involves drilling a borehole through a formation deep in the earth. Such boreholes are formed by connecting a drill bit to long sections of pipe, referred to as a “drill pipe,” so as to form an assembly commonly referred to as a “drill string.” The drill string extends from the surface, to the bottom of the borehole. The drill string is rotated, which causes the drill bit to be rotated. As the drill bit rotates, it advances into the earth, thereby forming the borehole. Oftentimes, the trajectory of borehole is directed by steering the drill bit either towards a target or away from an area where the drilling conditions are difficult. The process of drilling a borehole which is directed is referred to as “directional drilling.” A directional drilling tool generally sits behind a drill bit and forward of measurement tools. The directional drilling tool facilitates guiding the direction at which the drill bit proceeds as it moves further within the earth. Drilling operators have been trying to increase the ease and control of drill bit steerability, oftentimes with respect to changes or improvements being made to the directional drilling tool.

FIG. 1 shows a perspective view of a matrix drill bit 100 in accordance with the prior art. Referring to FIG. 1, the matrix drill bit 100, or drill bit, includes a bit body 110 that is coupled to a shank 115, or an upper section. The shank 115 includes a threaded connection 116 at one end 120 of the matrix drill bit 100. The threaded connection 116 couples to a drill string (not shown) or some other equipment that is coupled to the drill string. The threaded connection 116 is shown to be positioned on the exterior surface of the one end 120. This positioning assumes that the matrix drill bit 100 is coupled to a corresponding threaded connection located on the interior surface of a drill string. However, the threaded connection 116 at the one end 120 is alternatively positioned on the interior surface of the one end 120 if the corresponding threaded connection of the drill string is positioned on its exterior surface in other exemplary embodiments. A bore (not shown) is formed longitudinally through the shank 115 and the bit body 110 for communicating drilling fluid from within the drill string to a drill bit face 111 via one or more nozzles 114 formed in the drill bit face 111 during drilling operations.

The bit body 110 includes a plurality of blades 130 extending from the drill bit face 111 of the bit body 110 towards the threaded connection 116. The drill bit face 111 is positioned at one end of the bit body 110 furthest away from the shank 115. The plurality of blades 130 form the cutting surface of the matrix drill bit 100. One or more of these plurality of blades 130 are either coupled to the bit body 110 or are integrally formed with the bit body 110. A junk slot 122 is formed between each consecutive blade 130, which allows for cuttings and drilling fluid to return to the surface of the wellbore (not shown) once the drilling fluid is discharged from the nozzles 114. A plurality of cutters 140 are coupled to each of the blades 130 and extend outwardly from the surface of the blades 130 to cut through earth formations when the matrix drill bit 100 is rotated during drilling. The cutters 140 and portions of the bit body 110 deform the earth formation by scraping and/or shearing. The cutters 140 and portions of the bit body 110 are subjected to extreme forces and stresses during drilling which causes surface of the cutters 140 and the bit body 110 to eventually wear. Although one example of the matrix drill bit has been described, other matrix drill bits known to people having ordinary skill in the art are applicable to present invention described below.

FIG. 2 shows a side view and a partial cross-sectional view of the matrix drill bit 100 illustrating the internal components of the bit body 110 and the coupling between the bit body 110 and the shank 115 in accordance with the prior art. Referring to FIGS. 1 and 2, the bit body 110 further includes a blank 224 and a matrix 235 bonded to the blank 224. The matrix 235 defines a bore 240 therein and a plurality of passageways 245 extending from the bore 240 to the respective nozzle 114 in the drill bit face 111. The bore 240 of the bit body 110 is fluidly communicable with the bore of the shank 115 once the shank 115 is coupled to the bit body 110.

The blank 224 is a cylindrical steel casting mandrel that extends into the matrix 235. A portion of the blank 224 is positioned external to the matrix 235 while a remaining portion of the blank 224 extends centrally and longitudinally into the matrix 235 and surrounds the bore 240 formed within the matrix 235. According to the prior art, the blank 224 is generally fabricated from AISI 1020 steel. The blank 224, according to at least some of the prior art, includes a first portion 225, a second portion 226, a third portion 227, and a fourth portion 228. The first portion 225 is positioned external to the matrix 235 and includes threads 220 formed along the outer perimeter. However, in some alternative embodiments, the threads 220 are formed internally of the first portion 225. The second portion 226 also is positioned external to the matrix 235 and immediately adjacent to the matrix 235 between the first portion 225 and the matrix 235. The internal diameter of the first and second portions 225, 226 are similar while the outer diameter of the second portion 226 is greater than the outer diameter of the first portion 225. A top end of the second portion 226 is formed with a half-U shaped groove 231, via machining or in a mold. The third portion 227 is disposed within the matrix 225 and is positioned adjacent the second portion 226. The third portion 227 has an internal diameter similar to the internal diameters of the first and second portions 225, 226; however, the external diameter of the third portion 227 is variable as it transitions from the outer diameter of the second portion 226 to the outer diameter of the fourth portion 228. The fourth portion 228 is disposed within the matrix 235 and extends from the third portion 227 towards the bit face 111. The outer diameter of the fourth portion 228 is smaller than the outer diameter of the second portion 226 but larger than the outer diameter of the first portion 225. Further, the inner diameter of the fourth portion 228 is larger than the internal diameter of the first, second, and third portions 225, 226, 227.

The matrix 235 is formed from a sintering process and is fabricated from tungsten carbide powder and a binder material, such as cobalt, copper, cobalt alloy, copper alloy, or any other known material, such as a nickel or nickel alloy. Although tungsten carbide powder is used to form the matrix 235, other carbide powders can be used in lieu of or in conjunction with the tungsten carbide powder. The matrix 235 bonds to the blank 224 during a sintering process and surrounds the third and fourth portions 227, 228 of the blank 225.

The shank 115 further includes a second end 260 positioned distally away from the one end 120 of the matrix drill bit 100 and a plurality of bit breaker slots 270 formed at opposite sides thereof between the one end 120 and the second end 260. The second end 260 includes threads 262 formed internally therein and extending from the second end 260 towards the one end 120. The threads 262 are configured to be coupled threadedly with the threads 220 of the blank 224. The second end 260 is formed with a half-U shaped groove 261, via machining or molding, such that a U-shaped groove 265 is formed between the shank 115 and the blank 224 when the shank 115 is threadedly coupled to the blank 224 and the half U-shaped groove 231 of the blank 224 is positioned adjacent the half U-shaped groove 261 of the shank 115. The U-shaped groove 265 is formed with a 0.200 inch radius and a fifteen (15) degree angle; however, these dimensions may vary on other examples. According to the prior art, the shank 115 is generally fabricated from AISI 4140 steel.

In the prior art, the AISI 4140 shank 115 is welded by submerged arc welding (“SAW”) to the AISI 1020 blank 224 forming a U-groove joint 267 within the U-shaped groove 265. The U-shaped groove 265 allows access to the root of the weld when performing welding using the SAW weld technique, which is known to people having ordinary skill in the art and is not repeated herein for the sake of brevity. The U-shaped groove 265 is filled with multiple passes using the SAW weld technique, thereby forming the U-groove joint 267. The SAW welding technique makes use of a 0.062 inch diameter wire, Lincolnweld L61 consumable electrode material immersed in a protective layer of Lincoln 860 Flux. Since the U-groove joint 267 is a wide joint, the overall bit height of the matrix drill bit 100 becomes longer. A longer overall matrix bit height causes steerability of the matrix drill bit 100 to be more difficult and/or less efficient than if a shorter overall bit height were to be used.

### BRIEF DESCRIPTION OF THE DRAWINGS

The foregoing and other features and aspects of the invention will be best understood with reference to the following description of certain exemplary embodiments of the invention, when read in conjunction with the accompanying drawings, wherein:

FIG. 1 shows a perspective view of a matrix drill bit in accordance with the prior art;

FIG. 2 shows a side view and a partial cross-sectional view of the matrix drill bit of FIG. 1 illustrating the internal components of the bit body and the coupling between the bit body and the shank in accordance with the prior art;

FIG. 3 shows a side view and a partial cross-sectional view of a matrix drill bit illustrating the internal components therein and the coupling between the bit body and the shank in accordance with an exemplary embodiment of the present invention; and

FIG. 4 shows a side view and a partial cross-sectional view of a matrix drill bit illustrating the internal components therein and the coupling between the bit body and the shank in accordance with another exemplary embodiment of the present invention.

The drawings illustrate only exemplary embodiments of the invention and are therefore not to be considered limiting of its scope, as the invention may admit to other equally effective embodiments.

### DETAILED DESCRIPTION OF THE INVENTION

This invention relates generally to drill bits used in downhole drilling. More particularly, this invention relates to a matrix drill bit, such as a tungsten carbide matrix drill bit, having a reduced bit height and the methods for manufacturing the same. A matrix drill bit having a reduced distance from the cutters to the bend and/or from the cutters to the operative portion of the steering tool allows easier steering of the bit through a formation. Although the description provided below is related to a matrix drill bit, exemplary embodiments of the invention relate to any downhole tool including, but not limited to, rotary bits and shear bits, that benefit from having a reduced overall height.

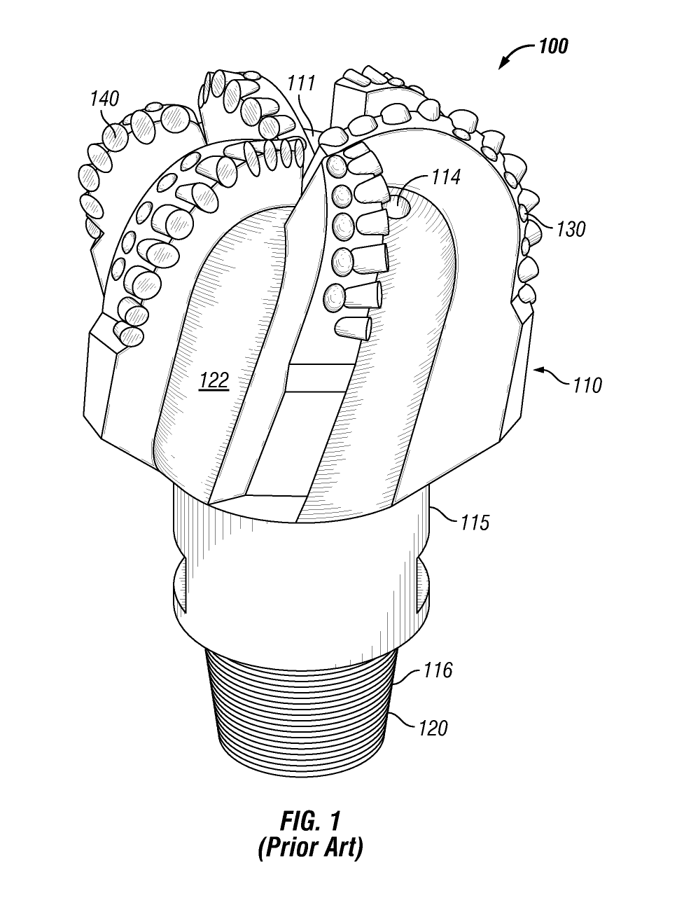

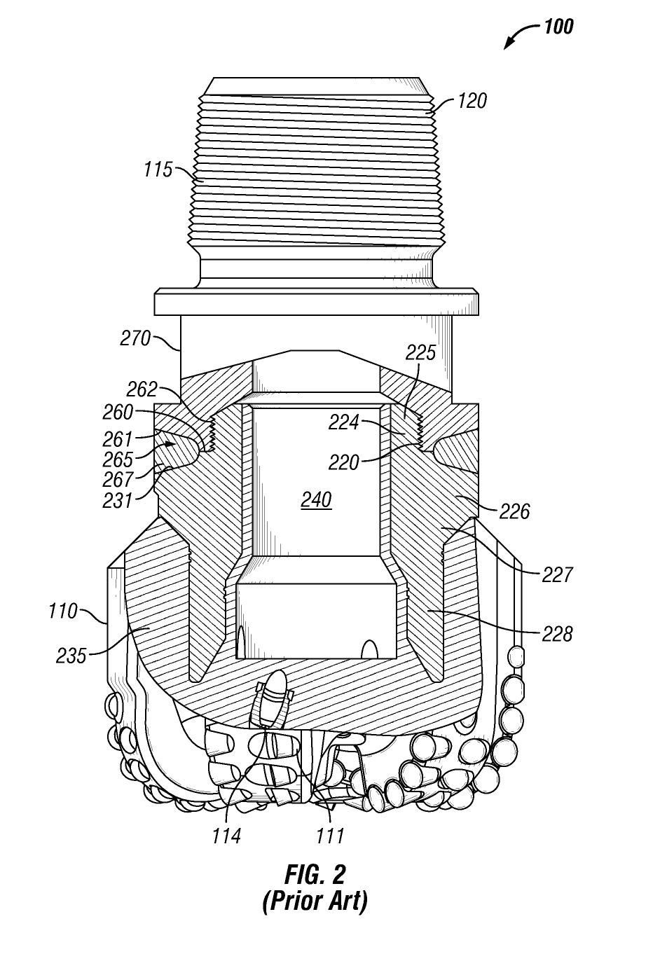

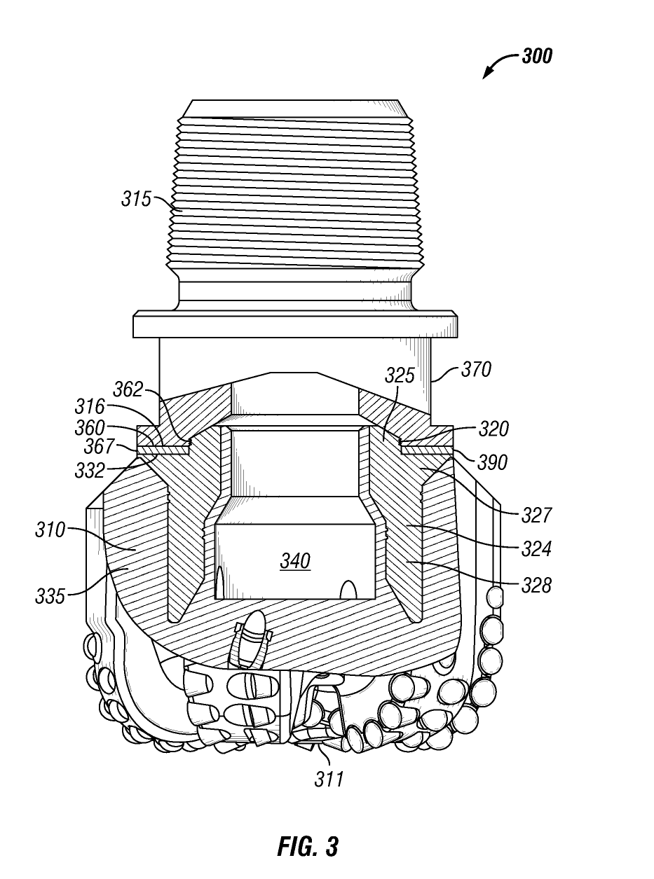

FIG. 3 shows a side view and a partial cross-sectional view of a matrix drill bit 300 illustrating the internal components therein and the coupling between the bit body 310 and the shank 315 in accordance with an exemplary embodiment of the present invention. Referring to FIG. 3, the matrix drill bit 300 is similar to matrix drill bit 100 (FIGS. 1 and 2) except for a portion of the shank 315, a portion of a blank 324, and a joint 367 coupling the blank 324 to the shank 315. The joint 367 is a butt-weld joint according to some exemplary embodiments, while it is a brazed joint according to other alternative exemplary embodiments. Hence, the remaining features of the matrix drill bit 300, which is similar to those corresponding features of the matrix drill bit 100 (FIG. 1), is not repeated herein for the sake of brevity.

According to certain exemplary embodiments, the blank 324 is a cylindrical steel casting mandrel, or a mandrel fabricated from other suitable material, that extends into a matrix 335, similar to the matrix 235 (FIG. 2). A portion of the blank 324 is positioned external to the matrix 335 while a remaining portion of the blank 324 is positioned centrally and longitudinally within the matrix 335 and surrounds a bore 340, similar to bore 240 (FIG. 2), formed within the matrix 335. The blank 324 is generally fabricated from AISI 1020 steel, but is fabricated from any other suitable material that is bondable, or made to be bondable, with the matrix 335 during a sintering process. According to certain exemplary embodiments, the blank 324 includes a first portion 325, an optional second portion (not shown), a third portion 327, and a fourth portion 328.

The first portion 325 is positioned external to the matrix 335 and includes threads 320 formed along the outer perimeter. The first portion 325 is similar to first portion 225 (FIG. 2), but is shorter in height than the first portion 225 (FIG. 2) in certain exemplary embodiments. Hence, there also are fewer threads 320 in the first portion 325 than in the first portion 225 (FIG. 2). Alternatively, the heights of both the first portion 325 and the first portion 225 (FIG. 2) are about the same.

The optional second portion, when formed, also is positioned external to the matrix 335 and immediately adjacent to the matrix 335 between the first portion 325 and the matrix 335. The internal diameter of the first and optional second portions 325, when formed, are similar while the outer diameter of the optional second portion is greater than the outer diameter of the first portion 325. The optional second portion is similar to the second portion 226 (FIG. 2), but is shorter in height than the second portion 226 (FIG. 2). At least a portion of the top end of the optional second portion, when formed, is formed with a substantially flat, planar surface, via machining or molding. Thus, when the optional second portion is formed, the substantially flat, planar surface of the second portion, or top end of the second portion, is positioned adjacently in contact, face-to-face, with a bottom end of the shank 315, which also is formed with a substantially flat, planar surface, as is further described below. As shown in FIG. 3, the optional second portion is not formed in that exemplary embodiment.

The third portion 327 is disposed within the matrix 325 and is positioned adjacent the optional second portion when formed, similar to the third portion 227 (FIG. 2) and the second portion 226 (FIG. 2). The third portion 327 has an internal diameter similar to the internal diameters of the first and optional second portions 325 (when formed); however, the external diameter of the third portion 327 is variable as it transitions from the outer diameter of the optional second portion 326 (when formed) to the outer diameter of the fourth portion 328. When the optional second portion is not formed as shown in FIG. 3, the third portion 327 is formed in a similar manner and includes an outer diameter that extends from the outer diameter of the fourth portion 328 outwardly an angle towards the upper surface of the matrix 335. Accordingly, in these exemplary embodiments, a top surface of the third portion 327 is formed with a substantially flat, planar surface 332, via machining or molding. Thus, when the optional second portion is not formed, the substantially flat, planar surface 332 of the third portion 327, or top surface of the third portion 327, is positioned adjacently in contact with a bottom end of the shank 315, which also is formed with a substantially flat, planar surface, as is further described below. According to some exemplary embodiments, the top surface of the third portion 327 is positioned external to the matrix 335.

The fourth portion 328 is disposed within the matrix 335 and extends from the third portion 327 towards the bit face 311, which is similar to bit face 111 (FIG. 1). The outer diameter of the fourth portion 328 is smaller than the outer diameter of the optional second portion (when formed) but larger than the outer diameter of the first portion 325. Further, the inner diameter of the fourth portion 328 is larger than the internal diameter of the first, optional second, and third portions 325, 327.

The matrix 335 is formed from a sintering process and is fabricated from tungsten carbide powder and a binder material, such as cobalt, copper, cobalt alloy, copper alloy, or any other known material, such as a nickel or nickel alloy. Although tungsten carbide powder is used to form the matrix 335, other carbide powders can be used. The matrix 335 bonds to the blank 324 during a sintering process and surrounds the third and fourth portions 327, 328 of the blank 325.

The shank 315 is similar to shank 215 (FIG. 2) except that shank 315 includes a second end 360 configured to be coupled to the blank 324. Optionally, the shank 315 also includes a plurality of bit breaker slots 370 formed at opposite sides thereof, similar to bit breaker slots 270 (FIG. 2). The second end 360 includes threads 362 formed internally therein and configured to be coupled threadedly with the threads 320 of the first portion 325 of the blank 224. The second end 360 is formed, via machining or molding, with a substantially flat, planar surface 316, such that surface 316 and surface 332 (or surface of second portion when used) are face-to-face and form a gap 390 therebetween measuring about 0.002 inches or less. In other exemplary embodiments, this gap 390 may be larger but accommodates a butt-weld joint 367 or a brazed joint 367 being formed therebetween. According to certain exemplary embodiments, the shank 315 is generally fabricated from AISI 4140 steel, but can be fabricated from any suitable material.

According to the exemplary embodiment illustrated in FIG. 3, the second end 360 of the shank 315 is threadedly coupled to the first portion 325 of the blank 324. Once threadedly coupled together, the surface 316 of the shank 315 is positioned face-to-face with the surface 332 of the third portion 327 of the blank 324 forming the gap 390 therebetween measuring about 0.002 inches or less. A butt-weld joint 367 is formed within this gap 390 to weldedly couple the shank 315 to the blank 324, thereby forming the matrix drill bit 300 having a reduced overall height than compared to the prior art matrix drill bit 100 (FIG. 1). This butt-weld joint 367 is formed using a “keyhole” welding process using plasma arc welding (“PAW”) or other deep penetration, narrow, minimal HAZ welding process including, but not limited to, electron beam welding (“EBW”), laser beam welding (“LBW”), inertia welding (“IW”), or other welding process, which are described in further detail below. Alternatively, a thin, braze joint 367 is formed in the gap 390 via induction, torch, or vacuum furnace brazing to couple the shank 315 to the blank 324, which is described in further detail below.

Although not illustrated in exemplary embodiment of FIG. 3, the blank 324 can include the optional second portion such that the second end 360 of the shank 315 is threadedly coupled to the first portion 325 of the blank 324 and once threadedly coupled together, the surface 316 of the shank 315 is positioned face-to-face with the surface (not shown) of the optional second portion of the blank 324 forming a gap (not shown) therebetween measuring about 0.002 inches or less. A butt-weld joint or a thin, brazed joint is formed within this gap, as mentioned above, to weldedly or brazedly couple the shank 315 to the blank 324, thereby forming the matrix drill bit 300 having a reduced overall height than compared to the prior art matrix drill bit 100 (FIG. 1).

Some of the welding process suited for welding a butt joint are electron beam welding, laser beam welding, plasma arc welding, or inertia welding. In plasma arc welding of certain thicknesses of base metals, “keyhole welding” is performed using special combinations of plasma gas flow, arc current, and weld travel speed. In the keyhole welding process, a relatively small weld pool with a hole, passes completely through the base metal, and is referred to as a “keyhole”. The plasma arc process is the only gas shielded welding process with this capability. In a stable keyhole operation, molten metal is displaced to the top bead surface by the plasma stream (in penetrating the weld joint) to form the characteristic keyhole. As the plasma torch is moved along the weld joint, metal melted by the arc is forced to move around the plasma stream and to the rear where the weld pool is formed and solidified. This flow of molten metal and the complete penetration of the metal thickness allows the impurities to flow to the surface and the gasses to be expelled more readily before solidification. The maximum weld pool volume and the resultant root surface profile are largely determined by the effects of a force balance between the molten weld metal surface tension and the plasma stream velocity characteristics. The high current keyhole technique of welding operates at conditions just below conditions that would actually cut through the metals, rather than weld the metals together. For cutting, a slightly higher orifice gas velocity blows the molten metal away. In welding, the gas velocity is just low enough that the surface tension of the molten metal hold it in the joint instead of blowing the molten metal out the bottom, as performed when cutting. Therefore orifice gas flow rates for welding are critical and are closely controlled. Variation of no more than 0.12 liters per minute in flow rate is the rule of thumb. Hence, the “keyhole” welding technique associated with welding by plasma arc welding (PAW) is implemented to achieve the deep narrow weld necessary to join the steel blank 324 to the shank 315, or upper section. A “keyhole” weld by PAW into a thin butt weld joint allow achievement of an overall height reduction in the bit.

Alternatively, in some other exemplary embodiments, the joint 367 is made by brazing the shank 315, or upper section, to the steel blank 324 using any number of brazing process including, but not limited to, torch brazing, induction brazing, or vacuum furnace brazing, using a copper, silver, or nickel based, or other suitable braze filler metal. For example, the shank 315 and the steel blank 324 are screwed together and held in place for the brazing process. According to certain exemplary embodiments, tackwells (not shown) are used to hold these components in place; however, other components are used in other exemplary embodiments. A filler material is applied in the gap formed between the two components. The components are then heated causing the filler material to flow into the gaps via capillary action. The components are then removed from the heat causing the filler material to cool down and join the two components together.

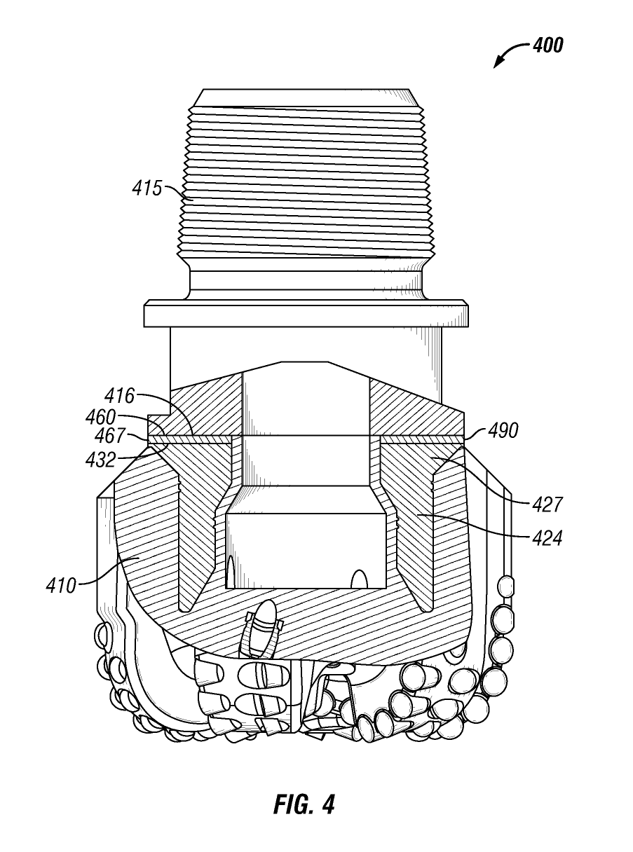

FIG. 4 shows a side view and a partial cross-sectional view of a matrix drill bit 400 illustrating the internal components therein and the coupling between the bit body 410 and the shank 415 in accordance with another exemplary embodiment of the present invention. Referring to FIG. 4, the matrix drill bit 400 is similar to matrix drill bit 300 (FIG. 3) except that the first portion 325 (FIG. 3) of the blank 324 (FIG. 3) is removed from the blank 324 (FIG. 3) to form a blank 424. Hence, a third portion 427, similar to third portion 227 (FIG. 3), includes a substantially flat, planar surface 432, which is similar to the substantially flat, planar surface 332 (FIG. 3). Further, the second end 360 (FIG. 3) of the shank 315 (FIG. 3) is extended inwardly to occupy the area that previously was occupied by the first portion 325 (FIG. 3) of the blank 324 (FIG. 3), thereby forming a second end 460 of the shank 415. The second end 460 is similar to second end 360 (FIG. 3) and includes a substantially flat, planar surface 416. The surface 416 is positioned adjacently and face-to-face with the surface 4332 (or surface of second portion when used) to form a gap 490, which is similar to the gap 390 (FIG. 3). Since the threaded portion of the blank 424 is removed, the shank 415 cannot be threadedly coupled to the blank 424 and is coupled only via a joint formed in the gap 490. The joint 467, similar to the joint 367 (FIG. 3), is formed within the gap 490 pursuant to the descriptions provided above.

Hence, a further reduction in overall bit height is achieved by eliminating the threaded portion of the connection between the steel blank 424 and the shank 415. The threaded connection was previously used, in the prior art, to hold the steel blank to the shank until the welder can lay a bead at the root of the single U groove. By implementing a butt joint in lieu of a single “U” groove, the threaded section is optional, but not necessary. The shank 415 is held steady to the steel blank 424 using other fixturing methods.

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims. It is therefore, contemplated that the claims will cover any such modifications or embodiments that fall within the scope of the invention.

What is claimed is:

1. A downhole tool, comprising:
a bit body comprising:
a blank comprising at least a first portion, a second portion coupled to the first portion, and a substantially first planar surface; and
a matrix bonded to and surrounding the blank, the matrix forming one or more blades extending outwardly in a direction away from the blank;
a shank comprising a threaded connection at one end and a second planar surface at a second end opposite the one end; and
a butt joint formed within a gap, the gap being formed between the first planar surface and the second planar surface when the first and second planar surface are positioned adjacently face-to-face with one another,
wherein the first portion of the blank is positioned external to the matrix and the second portion of the blank is positioned at least partially within the matrix, the first planar surface being positioned external to the matrix.

2. The downhole tool of claim 1, wherein the butt joint is formed using an electron beam welding process.

3. The downhole tool of claim 1, wherein the butt joint is formed using a plasma arc welding process.

4. The downhole tool of claim 1, wherein the butt joint is formed using a laser welding process.

5. The downhole tool of claim 1, wherein the butt joint is formed using an inertia welding process.

6. The downhole tool of claim 1, wherein the butt joint is formed using a brazing process, the brazing process being selected from at least one of an induction brazing process, a torch brazing process, or a vacuum furnace brazing process.

7. The downhole tool of claim 1, wherein the first portion comprises a first section and a second section, the first section comprising one or more threads, the second section disposed between the first section and the matrix and comprising the first planar surface, wherein the outer diameter of the first section is smaller than the outer diameter of the second section.

8. The downhole tool of claim 7, wherein the second portion comprises a third section and a fourth section, the third section disposed between the second section and the fourth section, the outer diameter of the fourth section being smaller than the outer diameter of the second section, the outer diameter of the third section transitioning between the outer diameter of the second section and the outer diameter of the fourth section.

9. The downhole tool of claim 1, wherein the blank is coupled to the shank via only the butt joint.

10. The downhole tool of claim 1, wherein the gap is maximum 0.002 inches or less from the first planar surface to the second planar surface.

11. The downhole tool of claim 1, wherein the second planar surface extends along the entire second end of the shank.

12. The downhole tool of claim 1, wherein the first planar surface extends along the entire end of the first portion of the blank.

13. A method for forming a matrix downhole tool having a reduced overall height, comprising:
obtaining a bit body comprising:
a blank comprising at least a first portion, a second portion coupled to the first portion, and a substantially first planar surface; and
a matrix bonded to and surrounding at least a portion of the blank, the matrix forming one or more blades extending outwardly in a direction away from the blank;
obtaining a shank comprising a threaded connection at one end and a second planar surface at a second end opposite the one end;
placing the first planar surface adjacently facing the second planar surface and forming a gap therebetween; and
forming a butt joint within the gap,
wherein the first portion of the blank is positioned external to the matrix and the second portion of the blank is positioned at least partially within the matrix, the first planar surface being positioned external to the matrix.

14. The method of claim 13, wherein the butt joint is formed using an electron beam welding process.

15. The method of claim 13, wherein the butt joint is formed using a plasma arc welding process.

16. The method of claim 13, wherein the butt joint is formed using a laser welding process.

17. The method of claim 13, wherein the butt joint is formed using an inertia welding process.

18. The method of claim 13, wherein the butt joint is formed using a brazing process, the brazing process being selected from at least one of an induction brazing process, a torch brazing process, or a vacuum furnace brazing process.

19. The method of claim 13, wherein the first portion comprises a first section and a second section, the first section comprising one or more threads, the second section disposed between the first section and the matrix and comprising the first planar surface, wherein the outer diameter of the first section is smaller than the outer diameter of the second section.

20. The method of claim 19, wherein the second portion comprises a third section and a fourth section, the third section disposed between the second section and the fourth section, the outer diameter of the fourth section being smaller than the outer diameter of the second section, the outer diameter of the third section transitioning between the outer diameter of the second section and the outer diameter of the fourth section.

21. The method of claim 13, wherein the blank is coupled to the shank via only the butt joint.

22. The method of claim 13, wherein the gap is maximum 0.002 inches or less from the first planar surface to the second planar surface.

23. The method of claim 13, wherein the second planar surface extends along the entire second end of the shank.

24. The method of claim 13, wherein the first planar surface extends along the entire end of the first portion of the blank.
